(19) United States
(12) Patent Application Publication
(10) Pub. No.: US 2007/0160298 A1
(43) Pub. Date: Jul. 12, 2007

(54) Image encoder, image decoder, image encoding method, and image decoding method

(76) Inventors: Tomokazu Murakami, Kokubunji (JP); Hiroaki Ito, Yokohama (JP); Isao Karube, Yokhama (JP); Masashi Takahashi, Yokohama (JP)

Correspondence Address: MCDERMOTT WILL & EMERY LLP, 600 13TH STREET, N.W., WASHINGTON, DC, 20005-3096, US

(21) Appl. No.: 11/485,626

(22) Filed: Jul. 13, 2006

(30) Foreign Application Priority Data
Jan. 10, 2006 (JP) 2006-001995

(51) Int. Cl. G06K 9/36

(52) U.S. Cl. 382/238

(57) ABSTRACT

The present invention provides a technique capable performing encoding with a high image quality and a low bit rate. An image encoder according to the present inventions includes: an image separation unit for separating a skeleton image and a texture image from an inputted image; a skeleton image encoding unit for encoding the skeleton image separated; a texture image encoding unit for encoding the texture image separated; a parameter adjustment unit for adjusting a parameter used in encoding processing of the skeleton image and the texture image; a parameter encoding unit for encoding the parameter; and a code multiplexing unit for multiplexing the skeleton image, the texture image, and the parameter which have been encoded.

### INCORPORATION BY REFERENCE

The present application claims priority from Japanese application JP2006-001995 filed on Jan. 10, 2006, the content of which is hereby incorporated by reference into this application.

### BACKGROUND OF THE INVENTION

1. Field of the Invention

The present invention relates to an image encoding technique for encoding an image and an image decoding technique for decoding an image.

2. Description of the Related Art

There is an encoding method such as MPEG (Moving Picture Experts Group) method as a method for digitizing, recording, and transmitting a large capacity of video and audio information which serves as the encoding method of the international standard as MPEG-1 standard, MPEG-2 standard, MPEG-4 standard, H.264/AVC (Advanced Video Coding) standard, and the like. These methods are employed as the encoding method in the digital satellite broadcast, DVD, mobile telephone, digital cameras, and the like. Their application range is now being widened and becoming everybody's near affairs.

By using the H.264/AVC, it is possible to encode an HD (High Definition) image into a high quality image with a bit rate of 8 to 10 Mbps. However, in order to transmit this at the radio band, it is necessary to further increase the compression ratio. As a method for realizing a method having a further higher compression ratio, there has been suggested an encoding method using the texture analysis called Texture Analysis/Texture Synthesis. This is disclosed, for example, in “A. Dumitras, B. Haskell: “A Texture Replacement Method at the Encoder for Bit-Rate Reduction of Compressed Video”, IEEE Transactions of Circuits and Systems for Video Technology, Vol. 13, No. 2, pp. 163-175, (2003).”

In the texture analysis encoding, a portion repeated with a constant pattern in the input image is expressed by an elemental texture and a texture parameter so that a encoding of high image quality can be performed with a very low bit rate. When the difference between an original image and a decoded image is compared in the pixel unit, the difference does not necessarily becomes smaller. However, subjectively, it is possible to realize a highly accurate image encoding as compared to the existing method.

### SUMMARY OF THE INVENTION

However, when an ordinary image is inputted in the texture encoding as disclosed in A. Dumitras, B. Haskell: “A Texture Replacement Method at the Encoder for Bit-Rate Reduction of Compressed Video”, IEEE Transactions of Circuits and Systems for Video Technology, Vol. 13, No. 2, pp. 163-175, (2003), it is difficult to enhance the texture analysis accuracy and it is difficult to encode with a low bit rate. Moreover, when the aforementioned encoding technique is employed for a complicated image, a synthesis noise may be generated.

The present invention provides a technique capable of performing encoding with a high image quality and a low bit rate.

For this, the present invention separates an original image into a skeleton image and a texture image which are encoded separately and the skeleton image and the texture image which have been separately encoded are multiplexed. It is preferable that the encoding parameter used when encoding the skeleton image and the texture image is adjusted so that the relationship between the entire code amount and the image quality is optimal. As an element for separating the texture image from the original image, for example, it is possible to use the Total Variation Filter.

Moreover, when decoding the image data which has been encoded as has been described above, it is possible to separately decode the skeleton image and the texture image which have been separately encoded and synthesize the decoded skeleton image and the texture image, thereby obtaining a final decoded image.

The separation into the skeleton image and the texture image, the encoding of the skeleton image, and the encoding of the texture image may be performed in block unit. Moreover, the decoding of the skeleton image, the decoding of the texture image, and the synthesis of the skeleton image and the texture image may be performed in block unit.

According to the present invention, it is possible to encode an image with a lower bit rate than the in the conventional method while maintaining the high image quality.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram of an image encoder according to a present embodiment.

FIG. 2 is a detailed block diagram of the image encoder according to the present embodiment.

FIG. 3 is a detailed block diagram of the image encoder according to the present embodiment.

FIG. 4 is a block diagram of the image encoder according to the present embodiment.

FIG. 5 is a detailed block diagram of the image encoder according to the present embodiment.

FIG. 6 is a detailed block diagram of the image encoder according to the present embodiment.

FIG. 7 is a block diagram of another image encoder according to the present embodiment.

FIG. 8 is a block diagram of another image encoder according to the present embodiment.

FIG. 9 is a diagram showing the concept of encoding processing according to the present embodiment.

FIG. 10 is a flowchart of the image encoding method according to the present embodiment.

FIG. 11 is a flowchart of the image encoding method according to the present embodiment.

FIG. 12 shows an image quality evaluation result when H.264/AVC is used for encoding both of the skeleton image and the texture image.

### DESCRIPTION OF THE INVENTION

Description will now be directed to the embodiments of the present invention with reference to the attached drawings.

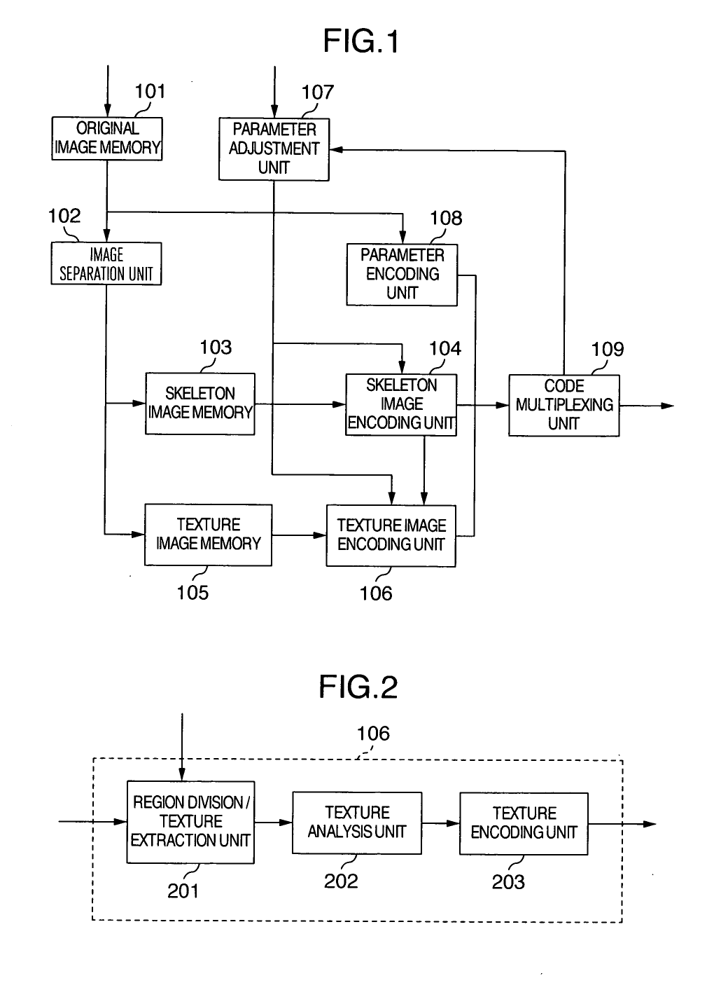

FIG. 1 shows an image encoder according to an embodiment of the present invention. The image encoder includes an original image memory (101) for holding an original image, an image separation unit (102) for separating a skeleton image as a first image and a texture image as a second image, a skeleton image memory (103) for holding the skeleton image, a skeleton image encoding unit (104) for encoding the skeleton image, a texture image memory (105) for holding the texture image, a texture image encoding unit (106) as a second image encoding unit for encoding the texture image, a parameter adjustment unit (107) for adjusting the encoding accuracy of the skeleton image and the texture image as a first image encoding unit, a parameter encoding unit (108) for encoding a parameter, and a code multiplexing unit (109) for multiplexing the encoding data.

The original image memory (101) holds an input image and passes it to the image separation unit (102). The image separation unit (102) separates the image into the skeleton image and the texture image. The separation method may be, for example, the Total Variation Filter disclosed in the documents shown below.

Document 1: L. Vese, S. Osher: “Modeling Textures with Total Variation Minimization and Oscillating Patterns in Image Processing”, Journal of Scientific Computing, Vol. 19, pp. 553-572.

Document 2: Nakagawa, Komatsu, Saito, “Separation of skeletons and textures from logarithmical image intensity and its applications”, I-4.11, Image Media Processing Symposium 2005 (2005).

The aforementioned documents 1 and 2 suggest a total variation filter for separating an image into a skeleton image formed by a flat portion and an edge of large intensity and a texture image formed by only a fine pattern portion. By using the total variation filter, it is possible to separate an image into a skeleton image and a texture image. In the aforementioned documents 1 and 2, the total variation filter is used for separating a texture from an original image to remove a noise or for creating an image with an emphasized texture. However, in the present embodiment, the total variation filter is used for image encoding.

Moreover, the filter may be an ordinary high-pass filter for separating a high frequency component or a wavelet filter. When the total variation filter is compared to the wavelet filter, the former can simultaneously obtain a skeleton image and a texture image having the same number of pixels while the latter can one skeleton image having ¼ number of pixels and three texture images. Accordingly, when using the latter, it is necessary to perform a plurality of texture encoding processes. It is possible to perform separation involving luminance and color difference or it is is also possible to separate only luminance and the color difference may be contained as it is in the skeleton image or the texture image.

In the aforementioned example, the texture separation is performed for a two-dimensional image. However, it is also possible to perform processing for a three-dimensional image including the time direction. The total variation filter uses the vicinity of the object image as a processing object but this can also be extended in the time direction. For example, an object frame and a prediction frame created for the object frame by motion compensation prediction from the preceding and the following frame are arranged side by side and pixels located at the same position as the pixels to be processed are added to the object pixels of the two-dimensional total variation filter, thereby extending the processing to three-dimensional processing.

Here, the skeleton image is an image containing a flat portion and an edge portion having an intensity higher than a certain value in the two-dimensional distribution of the image luminance. Since there are a lot of low-frequency components, it is possible to effectively perform encoding by the encoding method based on the existing hybrid encoding. When using the H.264/AVC, it is possible to increase the intra prediction and motion compensation prediction accuracy, thereby performing encoding with a high encoding efficiency.

The texture image is an image formed only by fine patterns. It is an image obtained by subtracting the skeleton image from the original image or dividing the original image. Since the aforementioned calculation result includes a negative value and a decimal part, it is necessary to add a certain number to shift the level or perform linear conversion to convert it into a normal image value range. When the total variation filter is used, the texture image is concentrated into a certain range of values and it becomes easier to perform encoding and analysis. For example, even when performing a texture analysis by using the method disclosed in A. Dumitras, B. Haskell: “A Texture Replacement Method at the Encoder for Bit-Rate Reduction of Compressed Video”, IEEE Transactions of Circuits and Systems for Video Technology, Vol. 13, No. 2, pp. 163-175, (2003), the analysis easier when using the texture image as input than directly using the original image as an input.

The skeleton image is held in a skeleton image memory (103) and encoded by a skeleton image encoding unit (104). The skeleton image can be encoded by using the encoding method based on the hybrid encoding. As has been described above, the skeleton image has a lot of low-frequency components and accordingly, it is possible to effectively perform encoding by using the existing method. Furthermore, it is possible to make the method more appropriate for encoding of the skeleton image by using the Hadamard Transform and modifying the pixel accuracy of the motion prediction.

The texture image is held in a texture image memory (105) and encoded by a texture image encoding unit (106). As the encoding method, it is possible to use the method disclosed in A. Dumitras, B. Haskell: “A Texture Replacement Method at the Encoder for Bit-Rate Reduction of Compressed Video”, IEEE Transactions of Circuits and Systems for Video Technology, Vol. 13, No. 2, pp. 163-175, (2003). Since texture separation is performed, it is possible to perform texture analysis with a higher accuracy than when the normal image is used.

As has been described above, the most appropriate encoding method is selected for each of the skeleton image and the texture image and an appropriate encoding parameter is used for encoding each of them. Thus, it is possible to increase the image quality of a re-synthesized image for a certain code amount. It is also possible to use the same encoding method for both of the skeleton image and the texture image. This case has a merit that it is possible to reduce the noise by the effect of texture separation.

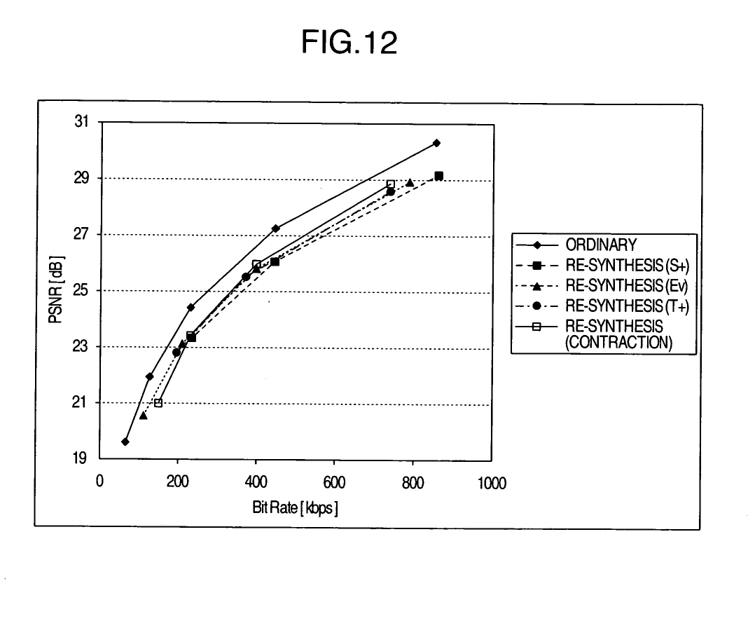

FIG. 12 shows a case when the H.264/AVC is used for encoding both of the skeleton image and the texture image. In this graph, the “normal” means encoding performed without performing texture separation. The “re-synthesis (S+)” shows a case when the image quality of the skeleton image is increased (the quantization parameter QP is lowered by 4). Moreover, the “re-synthesis (T+)” shows a case when the image quality of the texture image is increased (QP is lowered by 4). Furthermore, the “re-synthesis (contraction)” shows a case when the size of the skeleton image is reduced to half in both horizontal and vertical direction, i.e., to ¼ area and after encoding and decoding, the size is enlarged when performing re-synthesis. When the same encoding method is used both for the skeleton image and the texture image, the value of the entire PSNR (Peak Signal-to-Noise Ratio) is reduced, but subjective image degradation is not substantially caused. Moreover, when the image quality of each of the skeleton image and the texture image is controlled, it is possible to improve the entire image quality when the image quality of the texture image is improved (T+) or the size of the skeleton image is reduced (contraction).

The data encoded by the skeleton image encoding unit (104) and the texture image encoding unit (106) is multiplexed by a code multiplexing unit (109). Moreover, the encoding error measured in each of the encoding units and the encoded amount information are transmitted to a parameter adjustment unit (107).

The parameter adjustment unit (107) measures the skeleton image code amount and encoding error, the texture image code amount and encoding error, and encoding error when these are synthesized and adjusts the skeleton image and the texture image encoding parameter so as to minimize the encoding error for the code amount when the images are finally re-synthesized. For example, when the same H.264/AVC is used for encoding the skeleton image and the texture image, the entire image quality can be improved by increasing the texture image code amount ratio and reducing the skeleton image code amount even if the total code amount is the same. Since this ratio differs depending on the image characteristic and the frame, the encoding parameter is adjusted so as to control the skeleton image encoding unit (104) and the texture image encoding unit (106). Moreover, not only the code amount but also the separation ratio of the texture separation can be controlled in accordance with the image quality.

The parameter encoding unit (108) encodes the encoding parameter specified by the parameter adjustment unit (107), passes it to the code multiplexing unit (109) so as to be multiplexed on the stream.

FIG. 2 shows a detailed configuration of the texture image encoding unit (106). In the texture image encoding unit (106), firstly, a region division/texture extraction unit (201) divides the image into a plurality of regions and classifies them according to the texture type by utilizing the motion information sent from the skeleton image encoding unit (104). Next, by using the divided regions as processing units, a texture analysis unit (202) performs analysis.

The texture analysis unit (202) creates an elemental texture as the smallest unit when the region is expressed by a repeated pattern and calculates a texture parameter indicating what kind of pattern of the elemental texture synthesizes the other portion. Thus, each region is expressed by the elemental texture and the texture parameter. The elemental texture is small image data having a particular pattern. The texture parameter contains the region range, the position to which an elemental texture is attached, the type of the elemental texture, the elemental texture attachment method, the repeated pattern, the filter type when filtering after the attachment, and the like.

Next, the texture encoding unit (203) encodes and transmits the elemental texture and the texture parameter analyzed by the texture analysis unit (202).

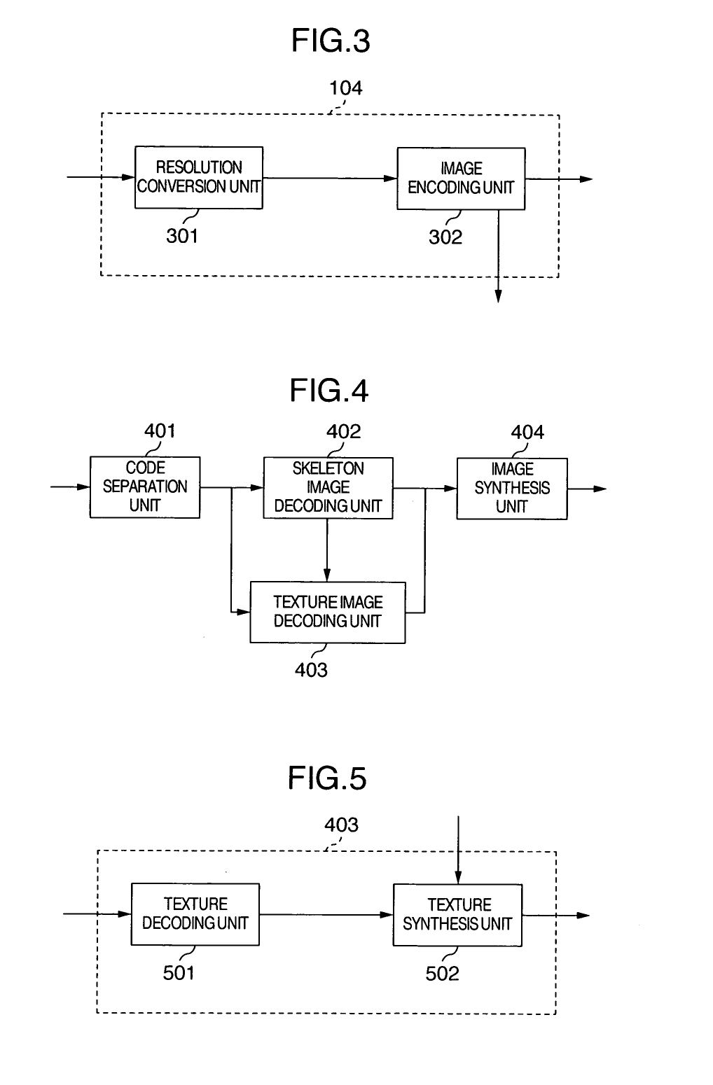

FIG. 3 shows a detailed configuration of the skeleton image encoding unit (104). A resolution conversion unit (301)performs resolution conversion of the skeleton image inputted. For example, the image size is reduced to half in the horizontal and vertical direction by using a contraction filter. Since the skeleton image has a high correlation in a space, substantial degradation is not caused even when contraction is performed by using a filter and there is a merit that the code amount can be reduced when encoding is performed. This resolution conversion may be omitted.

Next, an image encoding unit (302) encodes the skeleton image. This may be performed by using an encoding method based on the existing hybrid encoding such as the H.264/AVC. Information such as a motion vector is transmitted to the texture image encoding unit so as to be shared with the texture image encoding method. The skeleton image is encoded and the encoded data is outputted.

FIG. 4 shows an image decoder according to an embodiment of the present invention. The image decoder includes a code separation unit (401) for separating skeleton image data and texture image data, a skeleton image decoding unit (402) for decoding a skeleton image, a texture image decoding unit (403) for decoding a texture image, and an image synthesis unit (404) for re-synthesizing the decoded skeleton image and the texture image so as to obtain an output image.

The code separation unit (401) separates skeleton image data and texture image data from the encoded stream and passes them to the skeleton image decoding unit (402) and the texture image decoding unit (403), respectively.

The skeleton image decoding unit (402) decodes the skeleton image. This can be performed by using the decoding method corresponding to the encoding method used in the skeleton image encoding unit (104). The skeleton image decoded is passed to the image synthesis unit (404).

The texture image decoding unit (403) decodes the texture image. This can be performed by using the decoding method corresponding to the encoding method used in the texture image encoding unit (106). The texture image decoded is passed to the image synthesis unit (404).

The image synthesis unit (404) re-synthesizes the skeleton image and the texture image and acquires an output image. The synthesis method corresponds to the image separation unit (102). For example, when the texture image has been obtained by subtracting the skeleton image from the original image, the re-synthesized image can be obtained by adding the skeleton image and the texture image. When an offset has been added to each pixel of the texture image, the offset is subtracted.

FIG. 5 shows a detailed configuration of the texture image decoding unit (403). The texture decoding unit (501) decodes the encoded elemental texture and the texture parameter. The contents of the elemental texture and the texture parameter are as has been described above.

The texture synthesis unit (502) synthesizes a texture image from the elemental texture and the texture parameter. The elemental texture is attached to a range specified according to the texture parameter and repeatedly synthesized so as to obtain a texture image. For synthesizing the texture image, it is also possible to use information on the motion vector used when decoding the skeleton image.

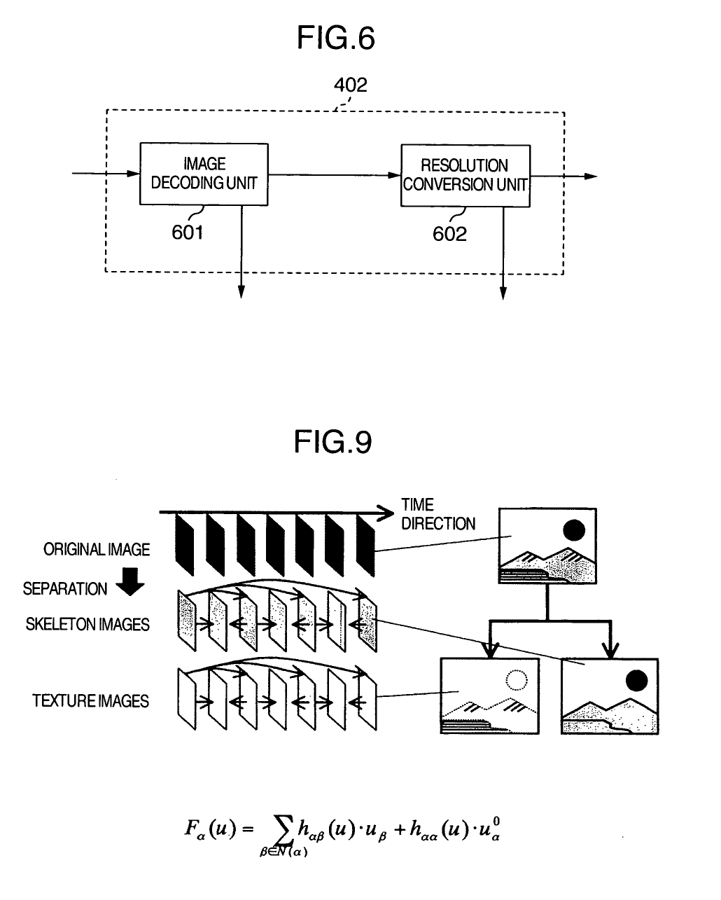

FIG. 6 shows a detailed configuration of the skeleton image decoding unit (402). The image decoding unit (601) decodes the skeleton image. This can be performed by using the decoding method corresponding to the encoding method used in the skeleton image encoding unit (302).

The resolution conversion unit (602) performs resolution conversion of the skeleton image. When the resolution conversion has been performed in the skeleton image encoding unit (104), this is returned to the original state. For example, when the size has been reduced to half in the horizontal and vertical direction by using the contraction filter, a corresponding enlarging filter is used to reset the original resolution. Thus, it is possible to obtain a skeleton image of a correct size.

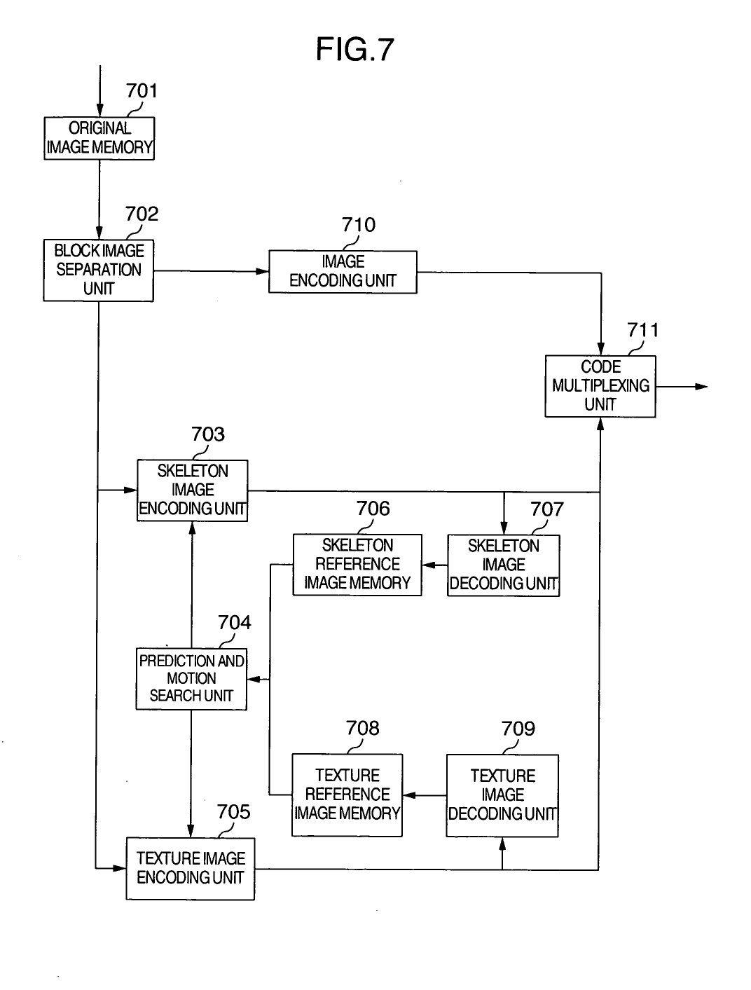

FIG. 7 shows an image encoder according to another embodiment of the present invention. The image encoder includes an original image memory (701), a block image separation unit (702), a skeleton image encoding unit (703), a prediction and motion search unit (704), a texture image encoding unit (705), a skeleton reference image memory (706), a skeleton image decoding unit (707), a texture reference image memory (708), a texture image decoding unit (709), an image encoding unit (710) performing normal image encoding, and a code multiplexing unit (710).

The embodiment shown in FIG. 7 performs texture separation between the skeleton image and the texture image in a certain block unit instead of the entire image. Moreover, it is possible to perform a normal image encoding for a block for which it is judged to be preferable to use the existing ordinary image encoding method rather than the encoding method using the texture separation in block unit. Thus, it is possible to adaptively use the texture separation image encoding method even for the inside of the image, thereby further improving the compression ratio.

The original image memory (701) holds an input image. The block image separation unit (702) divides the input image into block units and judges whether to encode the blocks by using the texture separation encoding method or the existing ordinary image encoding method. When the ordinary image encoding method is used, the processing is performed in the image encoding unit. When the texture separation encoding method is used, the skeleton image and the texture image are separated in block unit and the skeleton image is encoded in the skeleton image encoding unit (703) while the texture image is encoded in the texture image encoding unit (705).

In the skeleton image encoding unit (703), the skeleton image is encoded in block unit. The encoding method is the same as the one in the skeleton image encoding unit (104).

In the texture image encoding unit (705), the texture image is encoded in block unit. The encoding method is the same as the one in the texture image encoding unit (106).

The prediction and motion search unit (704) creates a prediction block by a motion search and intra prediction for the blocks of the skeleton image and the blocks of the texture image from the skeleton image reference image and the texture image reference image, respectively. The prediction method may be the existing H.264/AVC method or the like.

The skeleton reference image memory (706) holds the reference image of the skeleton image. The skeleton image decoding unit (707) decodes the skeleton image in block unit. The decoding method is the same as in the skeleton image decoding unit (402).

The texture reference image memory (708) holds the reference image of the texture image. The texture image decoding unit (709) decodes the texture image in block unit. The decoding method is the same as in the texture image decoding unit (403).

The image encoding unit (710) performs the existing encoding for the blocks for which not the texture separation encoding method but the existing encoding method has been selected.

The code multiplexing unit (711) multiplexes the encoded data in each block and outputs it as an encoded stream.

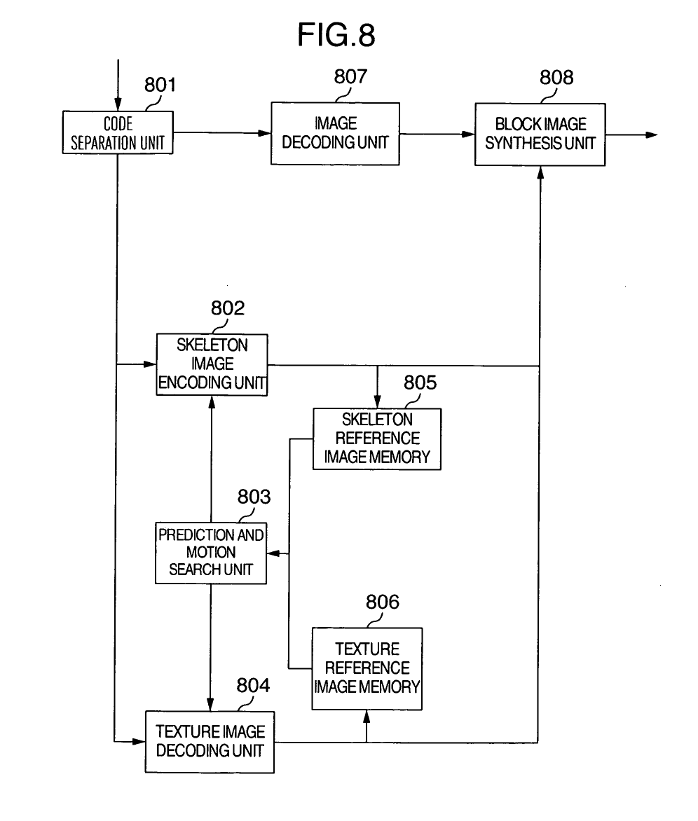

FIG. 8 shows an image decoder according to another embodiment of the present invention. The image encoder includes: an encoding separation unit (801); a skeleton image decoding unit (802); a prediction and motion search unit (803), a texture image decoding unit (804), a skeleton reference image memory (805). a texture reference image memory (806). an image decoding unit (807), and a block image synthesis unit (808).

The embodiment shown in FIG. 8 decodes an encoded stream by performing texture separation between the skeleton image and the texture image not for the entire image but in a certain block unit.

The code separation unit (801) separates an encoded stream and passes the data which has been encoded by the existing ordinary encoding method to the image decoding unit (807) performing ordinary decoding, the encoded data of a skeleton image encoded by the texture separation to the skeleton image decoding unit (802), and the encoded data of a texture image to the texture image decoding unit (804).

The skeleton image decoding unit (802) decodes the skeleton image in a block unit. The decoding method is the same as in the skeleton image decoding unit (707), (402).

The texture image decoding unit (804) decodes the texture image in a block unit. The decoding method is the same as in the texture image decoding unit (709), (403).

The prediction and motion search unit (803) creates a prediction block by the motion search and the intra prediction from the reference image of the skeleton image and the reference image of the texture image for the skeleton image block and the texture image block, respectively. The skeleton reference image memory (805) holds a reference image of the skeleton image. The texture reference image memory (806) holds a reference image of the texture image.

The image decoding unit (807) performs the existing decoding for the encoded blocks which have been encoded by using not the texture separation encoding method but the existing encoding method.

In case of the encoding using the texture separation for each block, the block image synthesis unit (808) creates a re-synthesized block by synthesizing the skeleton image and the texture image in block unit. For the blocks which have been decoded by using the existing method, it is applied as it is. Thus, re-synthesized image is created.

FIG. 9 is a block diagram showing a concept of the encoding method using the texture separation. In the image encoding method according to the present invention, frames of the original image arranged in the temporal direction are separated into the skeleton image and the texture image in the respective frames. The skeleton images and the texture images which have been separated are respectively encoded, multiplexed, and transmitted. The separation between the skeleton images and the texture images may be performed three-dimensionally by using information not only on the inside the frame but also on the frames arranged in the temporal direction. In this case, firstly, a prediction image is created by the motion compensation and a three-dimensional texture separation is performed on the prediction image. This enables more effective texture separation.

The texture separation method uses the total variation filter. This can be shows by using the Expressions 1 and 2 below.

$$\begin{matrix}{F}_{α} ( u ) = {\sum }_{β ∈ N ( α )} {h}_{α β} ( u ) \cdot {u}_{β} + {h}_{α α} ( u ) \cdot {u}_{α}^{0} & ( Expression 1 ) \\ {h}_{α β} ( u ) = \frac{{w}_{α β} ( u )}{λ + {\sum }_{γ ∈ N ( α )} {w}_{α γ} ( u )} \\ {h}_{α α} ( u ) = \frac{λ}{λ + {\sum }_{γ ∈ N ( α )} {w}_{α γ} ( u )} , & ( Expression 2 )\end{matrix}$$

Here, α indicates an object pixel position to be processed while β and γ indicate pixels in the vicinity of α. N(α) is a set of pixels in the vicinity of α such as 4-neighborhood and 8-neighborhood.

When performing temporal/spatial processing, pixels at the same position as α of the preceding and the following frame are added to the vicinity. “u” indicates the luminance value of the pixel. “w(u)” is a function in inverse proportion to the luminance difference between the pixels. “λ” is a parameter called fitting parameter for adjusting the texture separation degree. The total variation filter creates a skeleton image by repeatedly applying the filter of Expression 1. For the luminance of the pixel, that of the image repeatedly processed is used but the pixel of the input image is always used for the second term in Expression 1.

The encoded stream may be separately transmitted as the encoded data of the skeleton image and the encoded data of the texture image or they may be multiplexed and transmitted as one stream. When multiplexing the encoded data of the skeleton image and the encoded data of the texture image, a flag is set to distinguish these data.

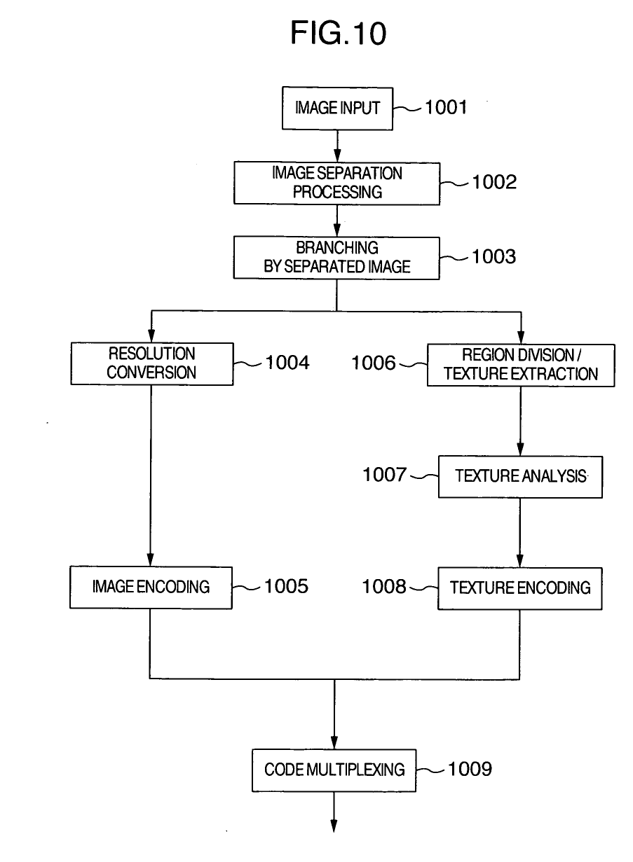

FIG. 10 shows an image encoding method according to an embodiment of the present invention as a flowchart starting with step (1001) and ending with step (1009).

In step (1001), an image is inputted. Next, in step (1002), an image separation processing is performed. The image separation processing is performed by using the total variation filter or the like. That is, texture separation is performed to create a skeleton image and a texture image. In step (1003), the processing is branched by the skeleton image and the texture image. For the skeleton image, control is passed to step (1004). For the texture image, control is passed to step (1006).

In step (1004), resolution conversion is performed for the skeleton image. As has been described above, the skeleton image has a high spatial correlation and it can be effectively encoded by contracting the image using the contraction filter while suppressing degradation. Step (1005) encodes the skeleton image. The skeleton image is encoded as has been described above.

Step (1006) performs region division and texture extraction for the texture image. Step (1007) performs texture analysis. Step (1008) performs texture encoding. The processes performed in these steps are as has been described above. Step (1009) multiplexes the encoded data on the skeleton image and the texture image.

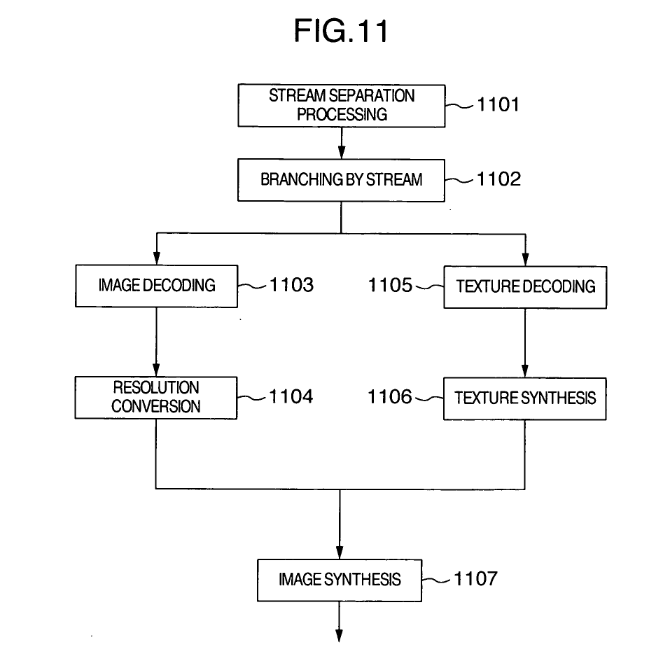

FIG. 11 shows an image decoding method according to an embodiment of the present invention as a flowchart starting with step (1101) and ending with step (1107).

Step (1101) performs separation of an encoded stream. Skeleton image data and texture image data are separated from the encoded stream. Step (1102) branches the process for the data type. For the skeleton image data, control is passed to step (1103). For the texture image data, control is passed to step (1105).

Step (1103) decodes the skeleton image. Step (1104) restores the original resolution of the skeleton image which has been contracted, by using a magnification filter. The processes performed in these steps are as has been described above.

Step (1105) decodes the texture. Step (1106) performs synthesis of the texture. The processes performed in these steps are as has been described above.

Step (1107) re-synthesizes the skeleton image and the texture image, so as to create an output image.

These processes realize the image encoding and decoding using the texture separation. By using the texture separation, it is possible to effectively compress the skeleton image and the texture image according to the encoding methods appropriate for each of them. Thus, it is possible to realize a higher compression ratio than the existing method. Especially, by using the texture analysis encoding for the encoding method of the texture image, it is possible to realize encoding having a high analysis accuracy and little synthesis noise. Moreover, since the image quality of each of them can be controlled separately, it is possible to improve the subjective image quality.

Furthermore, by applying the image encoding technique of the present embodiment to a video processing device such as a player, a mobile telephone, and a digital camera, it is possible to provide a video processing device having a high accuracy.

It should be further understood by those skilled in the art that although the foregoing description has been made on embodiments of the invention, the invention is not limited thereto and various changes and modifications may be made without departing from the spirit of the invention and the scope of the appended claims.

1. An image encoder comprising:
an image separation unit for separating an inputted image into a first image containing a first edge and a second image containing a frequency component lower than the first image and containing a second edge component larger than the first edge component and a flat portion;
a first image encoding unit for encoding the skeleton image separated;
a second image encoding unit for encoding the texture image separated;
a parameter encoding unit for encoding a parameter used for encoding of the skeleton image and the texture image; and
a code multiplexing unit for multiplexing the encoded first and second image and the encoded parameter.

2. An image encoder comprising:
an image separation unit for separating an inputted image into a skeleton image and a texture image;
a first image encoding unit for encoding the separated skeleton image;
a second encoding unit for encoding the separated texture image;
a parameter adjustment unit for adjusting an encoding parameter used for encoding of the skeleton image and the texture image;
a parameter encoding unit for encoding the parameter; and
a code multiplexing unit for multiplexing the encoded skeleton image, the texture image, and the parameter.

3. The image encoder as claimed in claim 2, wherein the parameter adjustment unit adjusts an encoding parameter in the first image encoding unit and the second encoding unit by using information obtained from the code multiplexing unit.

4. The image encoder as claimed in claim 1, further comprising:
an original image memory for storing the inputted image;
a skeleton image memory for storing the skeleton image separated by the image separation unit; and
a texture image memory for storing the texture image separated by the image separation unit.

5. The image encoder as claimed in claim 1, wherein the image separation unit separates the texture image from the inputted image by using a total variation filter.

6. The image encoder as claimed in claim 1, wherein the second image encoding unit has a region division/texture extraction unit for dividing an inputted image into a plurality of regions and extracting a texture, a texture analysis unit for analyzing the extracted texture, and a texture encoding unit for encoding the analyzed texture and a parameter.

7. The image encoder as claimed in claim 1, wherein the first image encoding unit has a resolution conversion unit for converting a resolution of the inputted skeleton image and an image encoding unit for encoding the skeleton image which has been subjected to the resolution conversion.

8. The image encoder as claimed in claim 1, wherein the image separation unit divides the input image into blocks and separates each of the blocks into a skeleton image and a texture image, and
the first and the second image encoding unit respectively perform encoding in the block unit.

9. The image encoder as claimed in claim 8, further comprising:
a skeleton image decoding unit for decoding the skeleton image which has been encoded by the first image encoding unit;
a skeleton reference image memory for holding the decoded skeleton image as a reference image for the skeleton image;
a texture image decoding unit for decoding the texture image which has been encoded by the second image encoding unit;
a texture reference image memory for holding the decoded texture image as a reference image for the texture image; and
a prediction and motion search unit for performing motion compensation in the block unit and creating a motion-predicted image by using the reference image held for the skeleton image and the reference image held for the texture image;
wherein the first and the second image encoding unit respectively perform encoding in the block unit by using the predicted image created by the prediction and motion search unit.

10. An image encoder comprising:
a code separation nit for separating a skeleton image stream and a texture image stream from a stream inputted;
a skeleton image decoding unit for decoding the skeleton image separated;
a texture image decoding unit for decoding the texture image separated; and
an image synthesis unit for synthesizing the skeleton image and the texture image which have been decoded;
wherein the skeleton image and the texture image which have been separately decoded are synthesized to obtain a finally decoded image.

11. The image encoder as claimed in claim 10, wherein the code separation unit divides the inputted image into blocks and separate a skeleton image and a texture image in the block unit, and the skeleton image decoding unit and the texture image decoding unit respectively perform decoding in the block unit.

12. The image encoder as claimed in claim 11, further comprising:
a skeleton reference image memory for holding the skeleton image decoded by the skeleton image decoding unit as a reference image for the skeleton image;
a texture reference image memory for holding the texture image decoded by the texture image decoding unit as a reference image for the texture image;
a prediction and motion search unit for performing motion compensation in the block unit and creating a motion-predicted image by using the reference image held for the skeleton image and the reference image held for the texture image;
wherein the skeleton image decoding unit and the texture image decoding unit respectively perform decoding in the block unit by using the predicted image created by the prediction and motion search unit.

13. An image encoding method comprising steps of:
separating an inputted image into a skeleton image and a texture image;
encoding the separated skeleton image;
encoding the separated texture image;
adjusting an encoding parameter used in encoding of the skeleton image and the texture image;
encoding the parameter; and
multiplexing the encoded skeleton image, the texture image, and the parameter.

14. An image decoding method comprising steps of:
separating a skeleton image stream and a texture image stream from an inputted stream;
decoding the separated skeleton image;
decoding the separated texture image; and
synthesizing the skeleton image and the texture image which have been separately encoded, so as to obtain a finally decoded image.

15. An image encoding stream obtained by encoding an image, comprising:
first encoded data obtained by encoding a skeleton image separated from an original image; and
second encoded data obtained by encoding a texture image separated from the original image;
wherein the first encoded data is multiplexed with the second encoded data.

16. The encoding stream as claimed in claim 15, wherein each of the first encoded data and the second encoded data has a flag to distinguish encoded data on the skeleton image from the encoded data on the texture image.
